(19) United States
(12) Patent Application Publication
(10) Pub. No.: US 2023/0174072 A1
(43) Pub. Date: Jun. 8, 2023

(54) METHOD AND APPARATUS FOR PROVIDING CONTEXT-BASED CONTENT

(71) Applicant: inDJ, Gwangju (KR)

(72) Inventor: Woo Ju JUNG, Gwangju (KR)

(73) Assignee: inDJ, Gwangju (KR)

(21) Appl. No.: 17/666,578

(22) Filed: Feb. 8, 2022

(30) Foreign Application Priority Data
Dec. 6, 2021 (KR) 10-2021-0173004

(51) Int. Cl. B60W 40/08; B60W 60/00; G01C 21/34; B60W 50/14

(52) U.S. Cl. CPC B60W 40/08; B60W 60/001; G01C 21/3407; B60W 50/14; B60W 2040/0872; B60W 2540/221; B60W 2530/00

(57) ABSTRACT

Provided are a method and an apparatus for providing context-based content. A method for providing content according to one embodiment of the present disclosure comprises identifying a vehicle driver; receiving an internal setting temperature of the vehicle; receiving internal and external temperature information of the vehicle, receiving current temperature setting information of other vehicles; determining whether the internal setting temperature of the vehicle is lower than a first threshold temperature; when the internal setting temperature of the vehicle is lower than the first threshold temperature, determining that the driver has a lot of body heat; and providing content according to the driver's physical constitution.

### BACKGROUND OF THE DISCLOSURE

### Field of the Disclosure

The present disclosure relates to smart mobility and, more particularly, to a method and an apparatus for providing content based on the context of a vehicle operated on a smart mobility platform.

### Related Art

Recently, as the vehicle-dependent lifestyle has become commonplace due to improved living standards, the amount of time people spend inside a vehicle increases gradually due to long-distance driving such as driving for travel or traffic jam. Accordingly, vehicles are now equipped with various convenience facilities and services for people staying in the vehicle for a long time.

A typical example among the convenience services is the telematics service. Telematics is a compound word that consists of telecommunication and information science. Telematics service is a next-generation information provision service for vehicles through a combination of the IT industry and the automobile industry, which closely associates wireless communication, vehicles, terminals, and content with each other.

Conventional telematics services utilize wireless communication technology and global positioning system (GPS) technology to provide various services through an in-vehicle terminal, such as traffic and driving information, emergency response information, remote vehicle diagnosis, Internet, e-mail, daily life information, and entertainment services.

Also, as the types of content consumed during driving are diversified, the telematics service is expanding into an integrated vehicle platform providing various types of content such as music and radio.

In this regard, Korea Laid-open Patent No. 10-2013-0036488 (publication date: Apr. 12, 2013) “Device for recommending sound source based on vehicle drive conditions” disclosed a method for automatically receiving and playing recommendations for preferred sound sources according to vehicle driving conditions. However, the disclosure has a disadvantage in that the content recommended according to vehicle driving conditions is limited only to sound sources.

Therefore, the present technical field needs a method for providing an integrated service on an autonomous driving platform.

### PRIOR ART REFERENCES

### Patents

Korea laid-open patent No. 10-2013-0036488, registered at Apr. 12, 2013 (Device for recommending sound source based on vehicle drive conditions)

### SUMMARY

A technical object of the present disclosure is to provide a method and an apparatus for providing content based on the context of a vehicle.

Another technical object of the present disclosure is to provide a method and an apparatus for providing an integrated service on an autonomous driving platform.

According to one aspect of the present disclosure, a method for providing content to a vehicle driver is provided. The method for providing content comprises identifying the vehicle driver; receiving an internal setting temperature of the vehicle; receiving internal and external temperature information of the vehicle; receiving current temperature setting information of other vehicles; determining whether the internal setting temperature of the vehicle is lower than a first threshold temperature; when the internal setting temperature of the vehicle is lower than the first threshold temperature, determining that the driver has a lot of body heat; and providing content according to the driver's physical constitution.

According to another aspect of the present disclosure, the receiving current temperature setting information of other vehicles receives and provides current temperature setting information set by the drivers of the other vehicles driving together with the vehicle in the same area and in the same time period or driving within a preconfigured threshold distance from the vehicle.

According to yet another aspect of the present disclosure, the first threshold temperature is a value obtained by subtracting a preconfigured threshold value from an average value of the received current temperature setting information set by the drivers of the other vehicles.

According to still another aspect of the present disclosure, the method for providing content further comprises determining whether the internal setting temperature of the vehicle is higher than a second threshold temperature and when the internal setting temperature of the vehicle is higher than the second threshold temperature, determining that the driver has less body heat.

According to yet still another aspect of the present disclosure, the second threshold temperature is a value obtained by adding a preconfigured threshold value to an average value of the received current temperature setting information set by the drivers of the other vehicles.

According to still yet another aspect of the present disclosure, the providing content according to a driver's physical constitution sets a famous restaurant within a threshold distance or at the closest distance as a destination of autonomous driving according to the driver's physical constitution.

According to further yet another aspect of the present disclosure, the method for providing content further comprises receiving information on the vehicle driver's physical constitution according to the past internal temperature settings of the vehicle driver, determining whether the internal setting temperature of the vehicle is lower than a third threshold temperature or higher than a fourth threshold temperature, and when the internal setting temperature of the vehicle is lower than the third threshold temperature or higher than the fourth threshold temperature, notifying the driver of a health problem.

According to further still another aspect of the present disclosure, the notifying the driver of a health problem further includes setting a hospital within a threshold distance or at the closest distance as a destination of autonomous driving according to the driver's physical constitution.

According to further yet still another aspect of the present disclosure, an apparatus for providing content to a vehicle driver is provided. The apparatus for providing content comprises a transceiver configured to receive an internal setting temperature of the vehicle, internal and external temperature information of the vehicle, and current temperature setting information of other vehicles; and a processor configured to identify the vehicle driver, determine whether the internal setting temperature of the vehicle is lower than a first threshold temperature, when the internal setting temperature of the vehicle is lower than the first threshold temperature, determine that the driver has a lot of body heat, and provide content according to the driver's physical constitution.

According to further still yet another aspect of the present disclosure, when receiving the current temperature setting information of the other vehicles, the transceiver receives current temperature setting information set by the drivers of the other vehicles driving together with the vehicle in the same area and in the same time period or driving within a preconfigured threshold distance from the vehicle.

According to even yet another aspect of the present disclosure, the first threshold temperature is a value obtained by subtracting a preconfigured threshold value from an average value of the received current temperature setting information set by the drivers of the other vehicles.

According to even still another aspect of the present disclosure, the processor determines whether the internal setting temperature of the vehicle is higher than a second threshold temperature and when the internal setting temperature of the vehicle is higher than the second threshold temperature, determines that the driver has less body heat.

According to even yet still another aspect of the present disclosure, the second threshold temperature is a value obtained by adding a preconfigured threshold value to an average value of the received current temperature setting information set by the drivers of the other vehicles.

According to even still yet another aspect of the present disclosure, when providing content according to the driver's physical constitution, the processor sets a famous restaurant within a threshold distance or at the closest distance as a destination of autonomous driving according to the driver's physical constitution.

According to even further yet another aspect of the present disclosure, the transceiver further receives information on the vehicle driver's physical constitution according to the past internal temperature settings of the vehicle driver; and the processor determines whether the internal setting temperature of the vehicle is lower than a third threshold temperature or higher than a fourth threshold temperature, and when the internal setting temperature of the vehicle is lower than the third threshold temperature or higher than the fourth threshold temperature, notifies the driver of a health problem.

According to even further still another aspect of the present disclosure, when the internal setting temperature of the vehicle is lower than the third threshold temperature or higher than the fourth threshold temperature, the processor sets a hospital within a threshold distance or at the closest distance as a destination of autonomous driving according to the driver's physical constitution.

According to the present disclosure, a method and an apparatus for providing content based on the context of a vehicle are provided.

Also, an integrated service is provided on an autonomous driving platform.

### BRIEF DESCRIPTION OF THE DRAWINGS

FIG. 1 illustrates a structure of a system for providing content based on the context of a vehicle according to one embodiment of the present disclosure.

FIG. 2 is a block diagram illustrating the structure of an apparatus for providing content based on the context of a vehicle according to one embodiment of the present disclosure.

FIG. 3 illustrates a method for providing content based on the context of a vehicle by an apparatus for providing content according to one embodiment of the present disclosure.

FIG. 4 illustrates a method for analyzing a driver's physical constitution by an apparatus for providing content according to one embodiment of the present disclosure.

FIG. 5 illustrates a method for notifying of a health problem by an apparatus for providing content according to one embodiment of the present disclosure.

FIG. 6 is a block diagram illustrating one example of a computer system according to one embodiment of the present disclosure.

### DESCRIPTION OF EXEMPLARY EMBODIMENTS

The present disclosure will be described in detail with reference to appended drawings as follows. In this document, repeated descriptions and detailed descriptions of known functions and configurations that may obscure the gist of the present disclosure will be omitted. The preferred embodiments of the present disclosure are provided in an attempt to more completely describe the present disclosure for those with average knowledge in the related art. Therefore, shapes and scales of constituting elements in the drawings may be exaggerated for the purpose of more clear descriptions of the present disclosure.

In what follows, preferred embodiments of the present disclosure will be described in detail with reference to appended drawings.

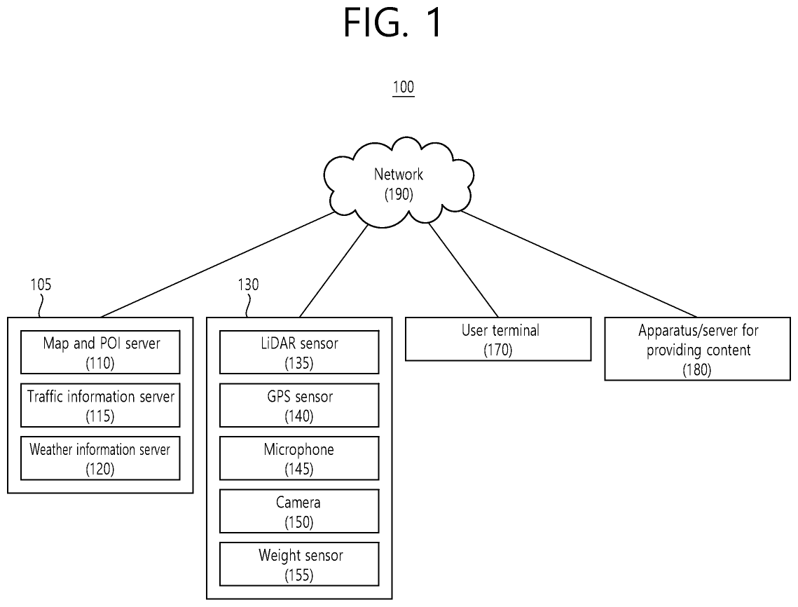

FIG. 1 illustrates a structure of a system for providing content based on the context of a vehicle according to one embodiment of the present disclosure.

Referring to FIG. 1, a content recommendation system 100 according to one embodiment of the present disclosure incudes an information provision server 105, a sensor 130, a user terminal 170, a network 190, and an apparatus for providing content 180.

The information provision server 105 provides external environment information around a current location of a vehicle and a destination location to provide customized content according to the context of the vehicle. The information provision server 105 includes a map and point of interest (POI) server 110, a traffic information server 115, and a weather information server 120.

Based on a path from a current location of a vehicle to a destination, the map and POI server 110 provides a map of a surrounding area and information on specific points that may be useful for or interesting to someone in the surrounding area of the path from the current location to the destination. For example, the location of Seoul tower on the map or information on famous restaurants around Namsan may be provided with respect to a current location.

The traffic information server 115 provides traffic information and a recommended path based on the traffic information with respect to the path from the current location of a vehicle to the destination.

The weather information server 120 provides weather information of the surrounding area with respect to the path from the vehicle's current location to the destination.

The sensor 130 obtains driving context information and in-vehicle information of the vehicle to provide customized content according to the context of the vehicle. The sensor 130 includes a Light Detection And Ranging (LiDAR) sensor 135, a Global Positioning System (GPS) sensor 140, a microphone 145, and a camera 150.

The LiDAR sensor 135 detects surrounding vehicles, obstacles, and pedestrians by emitting a laser beam around the vehicle and measuring the return time of the laser beam.

The GPS sensor 140 receives information on the current position of the vehicle from GPS satellites.

The microphone 145 records sounds inside and outside the vehicle. For example, the microphone 145 may be used to recognize the voice of the vehicle driver and obtain information on the driver.

The camera 150 takes pictures of the interior and exterior of the vehicle. For example, the camera 150 may be used to obtain information on the driver by photographing the vehicle driver. Also, the camera 150 may obtain information on the passengers remaining inside the vehicle.

The weight sensor 155 measures the weights of vehicle passengers to determine passenger information such as passenger weights or the number of passengers.

The sensor 130 includes the Light Detection And Ranging (LiDAR) sensor 135, Global Positioning System (GPS) sensor 140, microphone 145, camera 150, and weight sensor 155.

The user terminal 170 provides information on the driver to provide customized content according to the context of a vehicle. For example, the user terminal 170 provides the driver's age, gender, and search information.

The network 190 collects information obtained by the information provision server 105, sensor 130, and user terminal 170 and transmits the collected information to the apparatus/server for providing content 180.

The apparatus for providing content 180 provides customized content according to the context of a vehicle to the vehicle driver. The apparatus for providing content 180 may include a communication unit implemented for communication with the network 190 and a processor operatively connected to the communication unit.

Meanwhile, although FIG. 1 assumes that the information obtained by the sensor 130 and the user terminal 170 is transmitted to the apparatus for providing content 180 via the network 190, the apparatus for providing content 180 may obtain the information by performing communication directly with the sensor 130 and/or the user terminal 170.

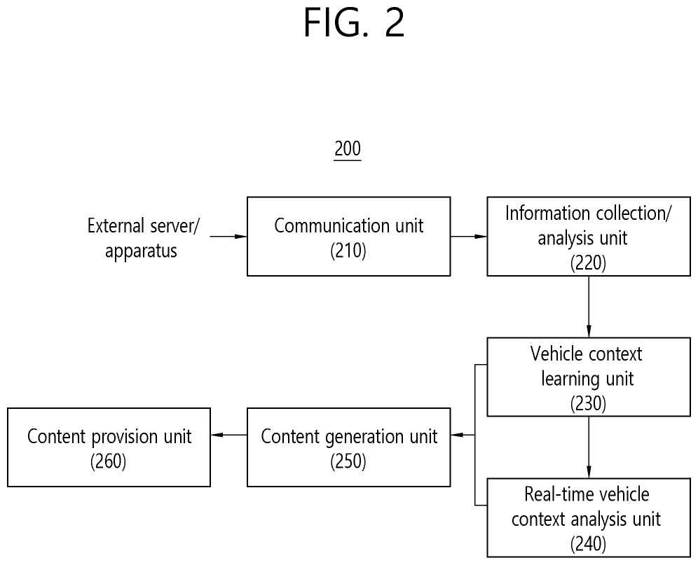

FIG. 2 is a block diagram illustrating the structure of an apparatus for providing content based on the context of a vehicle according to one embodiment of the present disclosure.

Referring to FIG. 2, the apparatus for providing content 200 according to the present disclosure comprises a communication unit 210, an information collection/analysis unit 220, a vehicle context learning unit 230, a real-time vehicle context analysis unit 240, a content generation unit 250, and a content provision unit 260.

Meanwhile, the apparatus for providing content 200 according to the present disclosure may be installed in a vehicle or provided integrally with the vehicle.

The communication unit 210 receives information on the vehicle context and the external environment from an external server or an external device and transmits the received information to the information collection/analysis unit 220. For example, the communication unit 210 may collect passenger information using weight sensors mounted on the vehicle's seats. The weight sensor is mounted on each of the seats provided in the vehicle, detects the weight of a passenger on the seat, and provides the detected value to the information collection/analysis unit 220.

At this time, the information received through the communication unit 210 may include information on external factors such as weather, temperature, humidity, illumination, time zone, driving road, and traffic conditions and information on internal factors such as vehicle speed, before/after driving, stop, parking, restart, and vehicle mode.

The information collection/analysis unit 220 may generate passenger type information based on the information received from the communication unit 210. For example, the information collection/analysis unit 220 may determine the presence or absence of a passenger and the gender of the passenger by comparing the weight of the passenger received from the weight sensor installed in the seat of the vehicle with a preconfigured weight. Accordingly, the information collection/analysis unit 220 may determine a current passenger type as a dating mode when passengers are seated on the driver's seat and a passenger seat, and genders of the passengers are different; a solo mode when a person is sitting only on the driver's seat; and a family mode when people are seated not only on the driver's seat and the passenger seat but also on the rear seat. The information collection/analysis unit 220 may transmit the determined passenger type information to the vehicle context learning unit 230 and the real-time vehicle context analysis unit 240. The vehicle context learning unit 230 learns the vehicle context based on the information received from the information collection/analysis unit 220 and transmits the learned vehicle context to the content generation unit 250.

The content generation unit 250 generates content based on the information received from the vehicle context learning unit 230 and the real-time vehicle context analysis unit 240.

The content provision unit 260 provides content generated by the content generation unit 250. Here, the content may include music, photos, and moving pictures such as drama, movies, and music videos. Recommended content information may include content files or an address of a streaming server that provides the corresponding content. Therefore, the content provision unit 260 may store and play content information or provide content in the form of a streaming service by accessing a streaming server.

The information collection/analysis unit 220 may receive vehicle context information in the form of unprocessed raw data or vehicle context type information from the communication unit 210. The information collection/analysis unit 220, which has received the vehicle context information in raw data, compares the received vehicle context information in raw data with a preconfigured vehicle context reference value to determine the type of vehicle context. As a result, the content generation unit 250 generates content based on the type of vehicle context and a pre-learned model according to the vehicle context.

Meanwhile, the real-time vehicle context analysis unit 240 determines whether an event has occurred based on the vehicle context received from the information collection/analysis unit 220 or the vehicle context learning unit 230. In the occurrence of an event, the content generation unit 250 and the content provision unit 260 immediately stop providing existing content in service but immediately provide content due to the occurrence of the event received from the real-time vehicle context analysis unit 240.

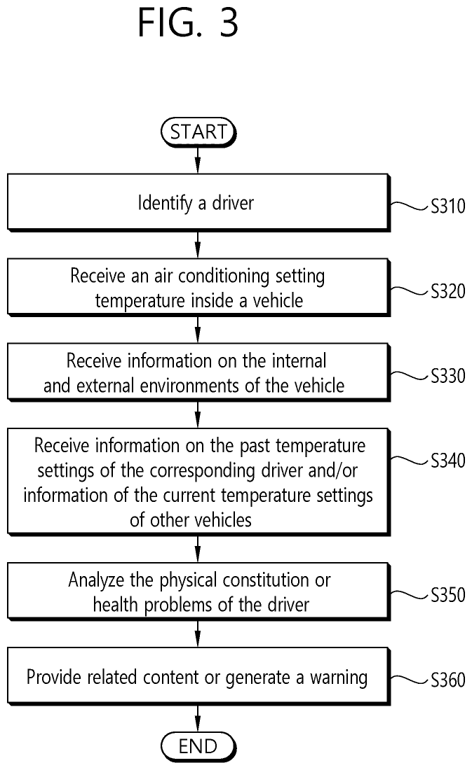

FIG. 3 illustrates a method for providing content based on the context of a vehicle by an apparatus for providing content according to one embodiment of the present disclosure.

Referring to FIG. 3, the apparatus for providing content identifies a vehicle driver S310. At this time, to identify a vehicle driver, user ID information may be used as unique information. At this time, a camera installed inside a vehicle, a microphone, a weight sensor installed in the driver seat, and a user terminal connected to the vehicle through Bluetooth may be used to identify a vehicle driver.

Meanwhile, after identifying a driver using one of the plurality of driver identification means, the apparatus for providing content may verify the identified driver using another driver identification means. For example, after identifying the vehicle driver using a camera or a microphone installed inside the vehicle, the apparatus for providing content may verify the identified driver by checking whether the weight of the identified driver lies within a threshold range using a weight sensor installed in the driver seat.

Also, the apparatus for providing content receives the internal setting temperature set for the vehicle by the corresponding driver S320. The information on the internal setting temperature for the vehicle may be received from an air conditioning system of the vehicle.

Also, the apparatus for providing content receives information on the internal and external environments of the vehicle S330. At this time, the information on the vehicle's internal and external environments may include the temperature inside and outside the vehicle. Also, the information on the vehicle's internal and external environments may include season, weather, time, and humidity.

Also, the apparatus for providing content receives information on the past temperature settings of the corresponding driver and/or information of the current temperature settings of other vehicles S340.

The information on the past temperature settings of the corresponding driver may be received from one of an external server, the driver's terminal, or a recording medium inside the vehicle.

The information on the past temperature settings by the corresponding driver may include the information on the internal temperature settings inside the vehicle set by the driver in the past and the information on the vehicle's internal and external environments at that time, such as season, weather, time, humidity, and temperature inside and outside the vehicle.

Meanwhile, the information on the current temperature settings of other vehicles may be received from an external server.

The information on the current temperature settings of other vehicles includes the information on the current temperature settings set by the drivers of the other vehicles driving together with the current vehicle in the same area and in the same time period or driving within a preconfigured threshold distance from the current vehicle.

Also, the apparatus for providing content analyzes the vehicle driver's physical constitution or health problem using the information on the vehicle driver identified in the S310 step, information on the internal setting temperature for the vehicle received in the S320 to S340 steps, information on the vehicle's internal and external environments, information on the temperature settings by the corresponding driver in the past, and/or information on the current temperature settings of other vehicles S350.

Also, based on the driver's physical constitution or health problem analyzed in the S350 step, the apparatus for providing content may provide related content or generate a warning S360.

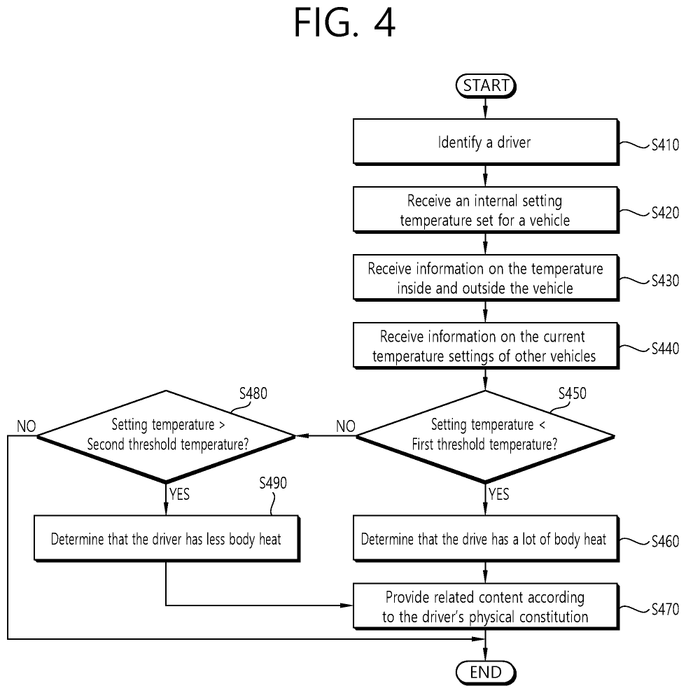

FIG. 4 illustrates a method for analyzing a driver's physical constitution by an apparatus for providing content according to one embodiment of the present disclosure.

Referring to FIG. 4, the apparatus for providing content identifies a vehicle driver S410. At this time, to identify a vehicle driver, user ID information may be used as unique information. At this time, a camera installed inside a vehicle, a microphone, a weight sensor installed in the driver seat, and a user terminal connected to the vehicle through Bluetooth may be used to identify a vehicle driver.

Meanwhile, after identifying a driver using one of the plurality of driver identification means, the apparatus for providing content may verify the identified driver using another driver identification means. For example, after identifying the vehicle driver using a camera or a microphone installed inside the vehicle, the apparatus for providing content may verify the identified driver by checking whether the weight of the identified driver lies within a threshold range using a weight sensor installed in the driver seat.

Next, the apparatus for providing content receives the internal setting temperature set for the vehicle by the corresponding driver S420. The information on the internal setting temperature for the vehicle may be received from an air conditioning system of the vehicle.

Next, the apparatus for providing content receives information on the temperature inside and outside the vehicle of the corresponding driver S430.

Next, the apparatus for providing content receives information on the current temperature settings of other vehicles S440.

Meanwhile, the information on the current temperature settings of the other vehicles may be received from an external server.

The information on the current temperature settings of the other vehicles may include the information on the current temperature settings set by the drivers of the other vehicles driving together with the current vehicle in the same area and in the same time period or driving within a preconfigured threshold distance from the current vehicle.

At this time, the information on the current temperature settings of the other vehicles may be received selectively from the information on the current temperature setting of a vehicle of which the internal and external temperatures are close to the temperatures inside and outside the corresponding driver's vehicle. For example, the internal and external temperatures of the other vehicles are compared with the internal and external temperatures of the corresponding driver's vehicle and are received selectively only when the differences are within a preconfigured threshold.

Next, the apparatus for providing content compares the internal setting temperature of the corresponding driver's vehicle with a first threshold temperature S450, determines that the corresponding driver has a lot of body heat when the internal setting temperature of the corresponding driver's vehicle is lower than the first threshold temperature S460, and provides related content according to the corresponding physical constitution S470.

In this case, the related content according to the physical constitution with a lot of body heat may be a recommendation for food. For example, information on cold food or a restaurant that sells cold food within a threshold distance or at the closest distance may be recommended. Examples of cold food may include eggplant and buckwheat.

Also, in the case of a self-driving vehicle, it is possible to set a destination to a famous restaurant that sells cold food within a threshold distance or at the closest distance.

Also, it is possible to recommend a route to a famous restaurant that sells cold food within a threshold distance or at the closest distance on a navigation device installed in the vehicle.

At this time, the first threshold temperature may be set as a value obtained by subtracting a preconfigured threshold value from an average setting temperature of different vehicles based on the information on the current temperature settings of the other vehicles received in the S440 step.

Meanwhile, when it is determined from the S450 step that the temperature set by the corresponding driver is higher than the first threshold temperature, the internal setting temperature of the corresponding driver's vehicle is compared with a second threshold temperature S480. When the internal setting temperature of the corresponding driver's vehicle is higher than the second threshold temperature, it is determined that the corresponding driver has less body heat S490, and content related to the corresponding physical constitution is provided S470.

In this case, the related content according to the physical constitution with less body heat may be a recommendation for food. For example, information on warm food that helps generate heat in the body or a restaurant that sells warm food helping generate heat in the body within a threshold distance or at the closest distance may be recommended. Examples of warm food that helps generate heat in the body may include ginger, jujube, and onion.

Also, in the case of a self-driving vehicle, it is possible to set a destination to a famous restaurant that sells warm food helping generate heat in the body within a threshold distance or at the closest distance.

Also, it is possible to recommend a route to a famous restaurant that sells warm food helping generate heat in the body within a threshold distance or at the closest distance on a navigation device installed in the vehicle.

At this time, the second threshold temperature may be set as a value obtained by adding a preconfigured threshold value to an average setting temperature of different vehicles.

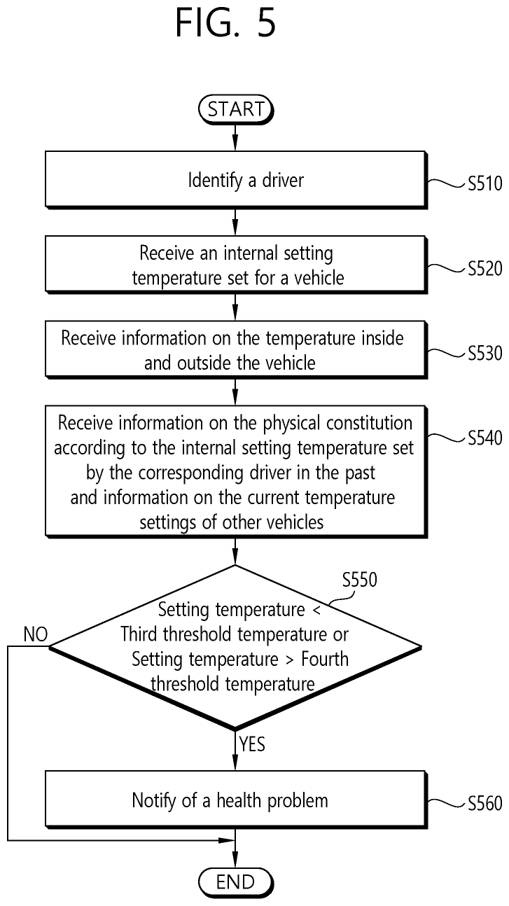

FIG. 5 illustrates a method for notifying of a health problem by an apparatus for providing content according to one embodiment of the present disclosure.

Referring to FIG. 5, the apparatus for providing content identifies a vehicle driver S510. At this time, to identify a vehicle driver, user ID information may be used as unique information. At this time, a camera installed inside a vehicle, a microphone, a weight sensor installed in the driver seat, and a user terminal connected to the vehicle through Bluetooth may be used to identify a vehicle driver.

Meanwhile, after identifying a driver using one of the plurality of driver identification means, the apparatus for providing content may verify the identified driver using another driver identification means. For example, after identifying the vehicle driver using a camera or a microphone installed inside the vehicle, the apparatus for providing content may verify the identified driver by checking whether the weight of the identified driver lies within a threshold range using a weight sensor installed in the driver seat.

Next, the apparatus for providing content receives the internal setting temperature set for the vehicle by the corresponding driver S520. The information on the internal setting temperature for the vehicle may be received from an air conditioning system of the vehicle.

Next, the apparatus for providing content receives information on the temperature inside and outside the corresponding driver's vehicle S530.

Next, the apparatus for providing content receives information on the physical constitution according to the internal setting temperature set by the corresponding driver in the past and information on the current temperature settings of other vehicles S540.

At this time, the information on the physical constitution due to the past temperature settings of the corresponding driver may be received from one of an external server, the driver's terminal, or a recording medium inside the vehicle.

Meanwhile, the information on the current temperature settings of other vehicles may be received from an external server.

The information on the current temperature settings of other vehicles includes the information on the current temperature settings set by the drivers of the other vehicles driving together with the current vehicle in the same area and in the same time period or driving within a preconfigured threshold distance from the current vehicle.

At this time, the information on the current temperature settings of the other vehicles may be received selectively from the information on the current temperature setting of a vehicle of which the internal and external temperatures are close to the temperatures inside and outside the corresponding driver's vehicle. For example, the internal and external temperatures of the other vehicles are compared with the internal and external temperatures of the corresponding driver's vehicle and are received selectively only when the differences are within a preconfigured threshold.

Next, the apparatus for providing content determines whether the internal setting temperature of the corresponding driver's vehicle is lower than a third threshold temperature or higher than a fourth threshold temperature S550. When it is determined that the internal setting temperature of the corresponding driver's vehicle is lower than the third threshold temperature or higher than the fourth threshold temperature, the apparatus for providing content determines that a health problem has occurred to the corresponding driver and notifies the driver of the health problem S560.

At this time, the third and fourth threshold temperatures may be configured based on the information on the physical constitution due to the internal temperature settings set by the corresponding driver in the past and the information on the current temperature settings of other vehicles received in the S550 step.

For example, the apparatus for providing content may calculate the average setting temperature of different vehicles based on the information on the current temperature settings of other vehicles received in the S550 step and then configure the third and fourth threshold temperatures based on a value modified according to the information on the physical constitution of the corresponding driver.

In one example, when the driver of the corresponding vehicle is a driver with an average physical constitution, a temperature one degree lower than the average setting temperature of other vehicles is set as the third threshold temperature, and a temperature one degree higher than the average setting temperature of the other vehicles is set as the fourth threshold temperature.

In another example, when the driver of the corresponding vehicle has a lot of body heat and tends to set the indoor temperature 0.5 degrees lower than other drivers, the third and fourth threshold temperatures may be set 0.5 degrees lower than the drivers with an average physical constitution. In other words, a temperature 1.5 degrees lower than the average setting temperature of other vehicles may be set as the third threshold temperature, and a temperature 0.5 degrees higher than the average setting temperature of the other vehicles may be set as the fourth threshold temperature.

Meanwhile, the apparatus for providing content may notify of a health problem in the S560 step and proceed with subsequent operations simultaneously.

For example, the apparatus for providing content may search for the nearest hospital from a current location of the vehicle, move immediately to a new destination by changing the destination of autonomous driving, and provide a route notification immediately through a navigation terminal installed inside the vehicle.

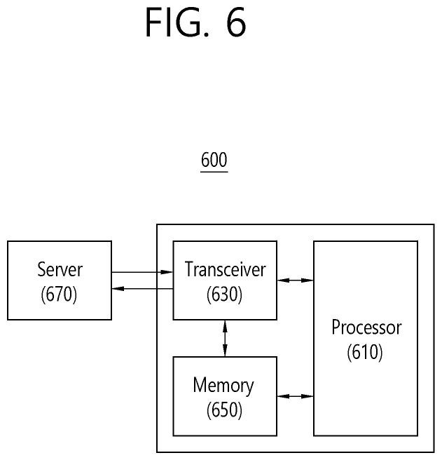

FIG. 6 is a block diagram illustrating one example of a computer system according to one embodiment of the present disclosure.

Referring to FIG. 6, an embodiment of the present disclosure may be implemented in a computer system such as a computer-readable recording medium. As shown in FIG. 6, a computer system 600 comprises a processor 610, a transceiver 630, and a memory 650; and the transceiver 630 performs communication with an external server 670.

The processor 610 implements a method for providing content in the apparatus for providing content according to the present disclosure. Specifically, the processor 610 implements all of the operations of the apparatus for providing content described in the embodiments of the present disclosure and performs all of the operations of the method for providing content described with reference to FIGS. 3 to 5.

For example, the processor 610 identifies a vehicle driver, determines whether an internal setting temperature of the vehicle is lower than a first threshold temperature, determines that the driver has a lot of body heat when the internal setting temperature of the vehicle is lower than the first threshold temperature, and provides content according to the driver's physical constitution.

At this time, the first threshold temperature may be a value obtained by subtracting a preconfigured threshold value from an average value of the received current temperature settings set by the drivers of different vehicles.

At this time, the processor 610 may determine whether the internal setting temperature of the vehicle is higher than a second threshold temperature and determine that the driver has a physical constitution with less body heat when the internal setting temperature of the vehicle is higher than the second threshold temperature.

At this time, the second threshold temperature may be a value obtained by adding a preconfigured threshold value to an average value of the received current temperature settings set by the drivers of different vehicles.

At this time, when content according to the driver's physical constitution is provided, the processor 610 may set a famous restaurant within a threshold distance or at the closest distance as a destination of autonomous driving according to the driver's physical constitution.

At this time, when the internal setting temperature of the vehicle is lower than the third threshold temperature or higher than the fourth threshold temperature, the processor 610 may set a hospital within a threshold distance or at the closest distance as a destination of autonomous driving according to the driver's physical constitution.

The transceiver 630 may obtain information directly by being connected to the processor 610 or transmit and/or receive information of the server 670. For example, the transceiver 630 receives the internal setting temperature of the vehicle, information on the temperature inside and outside the vehicle, and information on the current temperature settings of other vehicles.

At this time, when receiving the information on the current temperature settings of the other vehicles, the transceiver 630 may receive the information on the current temperature settings set by the drivers of the other vehicles driving together with the vehicle in the same area and in the same time period or driving within a preconfigured threshold distance from the vehicle.

At this time, the transceiver 630 may further receive information on the physical constitution according to the internal temperature settings set by the vehicle driver in the past.

The memory 650 may be a volatile or non-volatile recording medium in a various form. At this time, the memory 650 may store at least one of an internal setting temperature of a vehicle, information on the temperature inside and outside the vehicle, information on the current temperature settings of other vehicles, user ID, and first to fourth threshold temperatures.

The method and the apparatus for providing context-based content according to the present disclosure is not limited to the embodiments described above, but all or part of the embodiments may be combined selectively so that various modifications may be made to the embodiments.

### FIG. 1

110: Map and POI server
115: Traffic information server
120: Weather information server
135: LiDAR sensor
140: GPS sensor
145: Microphone
150: Camera
155: Weight sensor
170: User terminal
180: Apparatus/server for providing content
190: Network

### FIG. 2

External server/apparatus
210: Communication unit
220: Information collection/analysis unit
230: Vehicle context learning unit
240: Real-time vehicle context analysis unit
250: Content generation unit
260: Content provision unit

### FIG. 3

### Start

S310: Identify a driver
S320: Receive an air conditioning setting temperature inside a vehicle
S330: Receive information on the internal and external environments of the vehicle
S340: Receive information on the past temperature settings of the corresponding driver and/or information of the current temperature settings of other vehicles
S350: Analyze the physical constitution or health problems of the driver
S360: Provide related content or generate a warning

### End

### FIG. 4

### Start

S410: Identify a driver
S420: Receive an internal setting temperature set for a vehicle
S430: Receive information on the temperature inside and outside the vehicle
S440: Receive information on the current temperature settings of other vehicles
S450: Setting temperature<First threshold temperature?
S460: Determine that the drive has a lot of body heat
S470: Provide related content according to the driver's physical constitution
S480: Setting temperature>Second threshold temperature?
S490: Determine that the driver has less body heat

### End

### FIG. 5

### Start

S510: Identify a driver
S520: Receive an internal setting temperature set for a vehicle
S530: Receive information on the temperature inside and outside the vehicle
S540: Receive information on the physical constitution according to the internal setting temperature set by the corresponding driver in the past and information on the current temperature settings of other vehicles
S550: Setting temperature<Third threshold temperature or
Setting temperature>Fourth threshold temperature
S560: Notify of a health problem

### End

### FIG. 6

610: Processor
630: Transceiver
650: Memory
670: Server

What is claimed is:

1. A method for providing content to a vehicle driver, the method comprising:
identifying the vehicle driver;
receiving an internal setting temperature of the vehicle;
receiving internal and external temperature information of the vehicle;
receiving current temperature setting information of other vehicles;
determining whether the internal setting temperature of the vehicle is lower than a first threshold temperature;
when the internal setting temperature of the vehicle is lower than the first threshold temperature, determining that the driver has a lot of body heat; and
providing content according to the driver's physical constitution.

2. The method of claim 1, wherein the receiving current temperature setting information of other vehicles receives current temperature setting information set by the drivers of the other vehicles driving together with the vehicle in the same area and in the same time period or driving within a preconfigured threshold distance from the vehicle.

3. The method of claim 2, wherein the first threshold temperature is a value obtained by subtracting a preconfigured threshold value from an average value of the received current temperature setting information set by the drivers of the other vehicles.

4. The method of claim 2, further comprising:
determining whether the internal setting temperature of the vehicle is higher than a second threshold temperature; and
when the internal setting temperature of the vehicle is higher than the second threshold temperature, determining that the driver has less body heat.

5. The method of claim 4, wherein the second threshold temperature is a value obtained by adding a preconfigured threshold value to an average value of the received current temperature setting information set by the drivers of the other vehicles.

6. The method of claim 1, wherein the providing content according to a driver's physical constitution sets a famous restaurant within a threshold distance or at the closest distance as a destination of autonomous driving according to the driver's physical constitution.

7. The method of claim 1, further comprising:
receiving information on the vehicle driver's physical constitution according to the past internal temperature settings of the vehicle driver;
determining whether the internal setting temperature of the vehicle is lower than a third threshold temperature or higher than a fourth threshold temperature; and
when the internal setting temperature of the vehicle is lower than the third threshold temperature or higher than the fourth threshold temperature, notifying the driver of a health problem.

8. The method of claim 7, wherein the notifying the driver of a health problem further includes setting a hospital within a threshold distance or at the closest distance as a destination of autonomous driving according to the driver's physical constitution.

9. An apparatus for providing content to a vehicle driver, the apparatus comprising:
a transceiver configured to receive an internal setting temperature of the vehicle, internal and external temperature information of the vehicle, and current temperature setting information of other vehicles; and
a processor configured to identify the vehicle driver, determine whether the internal setting temperature of the vehicle is lower than a first threshold temperature, when the internal setting temperature of the vehicle is lower than the first threshold temperature, determine that the driver has a lot of body heat, and provide content according to the driver's physical constitution.

10. The apparatus of claim 9, wherein, when receiving the current temperature setting information of the other vehicles, the transceiver receives current temperature setting information set by the drivers of the other vehicles driving together with the vehicle in the same area and in the same time period or driving within a preconfigured threshold distance from the vehicle.

11. The apparatus of claim 10, wherein the first threshold temperature is a value obtained by subtracting a preconfigured threshold value from an average value of the received current temperature setting information set by the drivers of the other vehicles.

12. The apparatus of claim 10, wherein the processor determines whether the internal setting temperature of the vehicle is higher than a second threshold temperature and when the internal setting temperature of the vehicle is higher than the second threshold temperature, determines that the driver has less body heat.

13. The apparatus of claim 12, wherein the second threshold temperature is a value obtained by adding a preconfigured threshold value to an average value of the received current temperature setting information set by the drivers of the other vehicles.

14. The apparatus of claim 9, wherein, when providing content according to the driver's physical constitution, the processor sets a famous restaurant within a threshold distance or at the closest distance as a destination of autonomous driving according to the driver's physical constitution.

15. The apparatus of claim 9, wherein the transceiver further receives information on the vehicle driver's physical constitution according to the past internal temperature settings of the vehicle driver; and
the processor determines whether the internal setting temperature of the vehicle is lower than a third threshold temperature or higher than a fourth threshold temperature, and when the internal setting temperature of the vehicle is lower than the third threshold temperature or higher than the fourth threshold temperature, notifies the driver of a health problem.

16. The apparatus of claim 15, wherein, when the internal setting temperature of the vehicle is lower than the third threshold temperature or higher than the fourth threshold temperature, the processor sets a hospital within a threshold distance or at the closest distance as a destination of autonomous driving according to the driver's physical constitution.
